(19) United States
(12) Patent Application Publication
(10) Pub. No.: US 2007/0006738 A1
(43) Pub. Date: Jan. 11, 2007

(54) Method and apparatus for pan with central stirring device

(76) Inventor: Brian K. Beesley, Salt Lake City, UT (US)

Correspondence Address: THORPE NORTH & WESTERN, LLP., 8180 SOUTH 700 EAST, SUITE 200, SANDY, UT, 84070, US

(21) Appl. No.: 11/454,111

(22) Filed: Jun. 14, 2006

Related U.S. Application Data
(60) Provisional application No. 60/690,978, filed on Jun. 15, 2005.

(51) Int. Cl. A21B 7/00

(52) U.S. Cl. 99/348

(57) ABSTRACT

A cooking container, such as a roasting pan used for roasting almonds, that has a central agitation device that stirs or agitates the contents of the cooking container without leaving a stagnation point on the cooking surface of the container so that the contents will not burn. The central agitation device includes a central pedestal that forms an annular cooking surface and a toroidal cooking volume between the central pedestal and a sidewall of the cooking container, and agitation utensils, such as stirring rods, that can be rotatably mounted on the central pedestal. Turning means rotate the agitation utensils through the cooking volume.

### RELATED APPLICATIONS

Priority of U.S. Provisional patent application Ser. No. 60/690,978 filed on Jun. 15, 2005 is claimed which is herein incorporated by reference in its entirety for all purposes.

### BACKGROUND OF THE INVENTION

1. Field of the Invention

The present invention relates generally to frying and roasting pans. More particularly, the present invention relates to a device for stirring the contents of a roasting or frying pan.

2. Related Art

Cooking in a frying or roasting pan is very common. Most roasting or frying pans are circular, have a flat bottom, curved sides, and a handle-extending away from the pan from a side location. When cooking ingredients are placed in a pan and the pan is placed over a heat source, the contents of the pan will burn without stirring or some other form of agitation. Such agitation is usually provided by a person with a stirring implement like a spatula.

Some pans have stirring devices attached to them. These devices may be attached to the center of the pan and extend across the bottom of the pan, and up the side. A handle may be attached to the stirring device so that the contents of the pan may be stirred by turning the handle about the diameter of the pan. Such stirring devices will agitate the majority of the contents of the pan, however, since the stirring device is attached to, and swings about, the center of the pan, contents of the pan that are located at the center will remain undisturbed, and are highly likely to burn.

### SUMMARY OF THE INVENTION

It has been recognized that it would be advantageous to develop a cooking container, such as a roasting or frying pan for roasting and glazing almonds and other nuts, that has a stirring device that agitates the contents of the pan without leaving an undisturbed, or stagnant location where the contents may burn.

The present invention provides a cooking container with a bottom surface, and a sidewall. A central pedestal is coupled to the approximate center of the bottom surface of the cooking container to form an annular cooking surface on the bottom surface and a toroidal cooking volume between the central pedestal and a sidewall of the cooking container. An axle rod is coupled to the approximate center of the top surface of the central pedestal. A collar is rotatably coupled to the axle rod above the central pedestal. One or more agitation utensils are coupled to the collar. Turning means, such as a rotator, are removably coupled to the collar to rotate the collar, thereby rotating the agitation utensils through the cooking volume.

In accordance with another aspect of the present invention, an agitation device can be inserted into a conventional off the shelf cooking container, such as a frying or roasting pan for roasting and glazing almonds and other nuts. The device includes a central pedestal that is configured to be placed on a bottom surface of a cooking container which will form an annular cooking surface on the bottom surface and a toroidal cooking volume between the central pedestal and a sidewall of the cooking container. An axle rod is coupled to a central location on a top surface of the central pedestal. A collar is rotatably coupled to the axle rod above the central pedestal. At least one agitation utensils are removably coupled to the collar. Turning means are removably coupled to the collar to rotate the collar thereby rotating the agitation utensils through the toroidal cooking volume.

In accordance with another aspect of the present invention, a method for agitating food in a cooking container includes providing a cooking container having an agitation utensil rotatably coupled to a central pedestal. Food ingredients can be placed into the cooking container. The cooking container can be placed on a heat source. The agitation device can be rotated to agitate the food ingredients to prevent stagnation and burning while over the heat source.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is an exploded perspective view of a cooking container with an agitation device in accordance with an embodiment of the present invention;

FIG. 2 is a perspective view of the cooking container and agitation device of FIG. 1;

FIG. 3 is a side view of the cooking container and agitation device of FIG. 1;

FIG. 4 is a top view of the cooking container and agitation device of FIG. 1;

FIG. 5 is a cross section view of the agitation device of FIG. 1;

FIG. 6 is a side view of a cooking container with an agitation device in accordance with another embodiment of present invention; and

FIG. 7 is a side view of an agitation device in accordance with another embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The present invention provides a cooking container, such as a roasting pan used for roasting almonds or other nuts, that has a central agitation device that can stir or agitate the contents of the cooking container without leaving a stagnation point on the cooking surface of the container, so that the contents will not burn. The central agitation device can include one or more agitation utensils, such as stirring rods that can be rotatably mounted on a pedestal located in the center of the cooking container. Turning means, such as an electric motor or a handle, can be coupled to the central agitation device and can turn the agitation utensils through a portion, or through the entire cooking volume of the container.

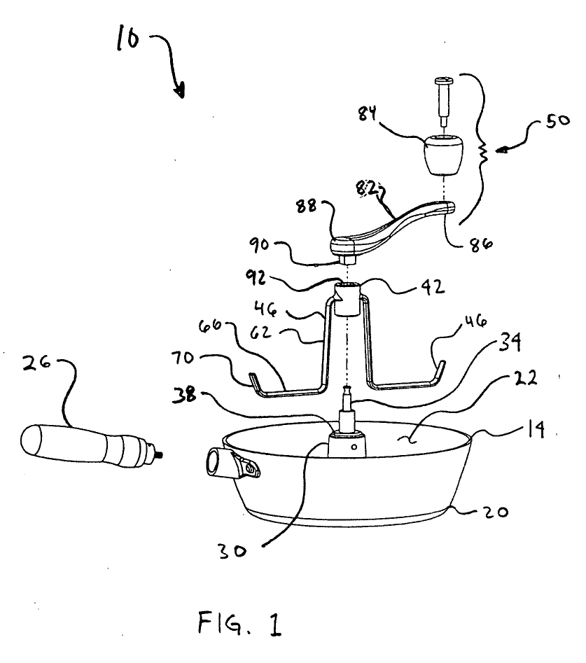

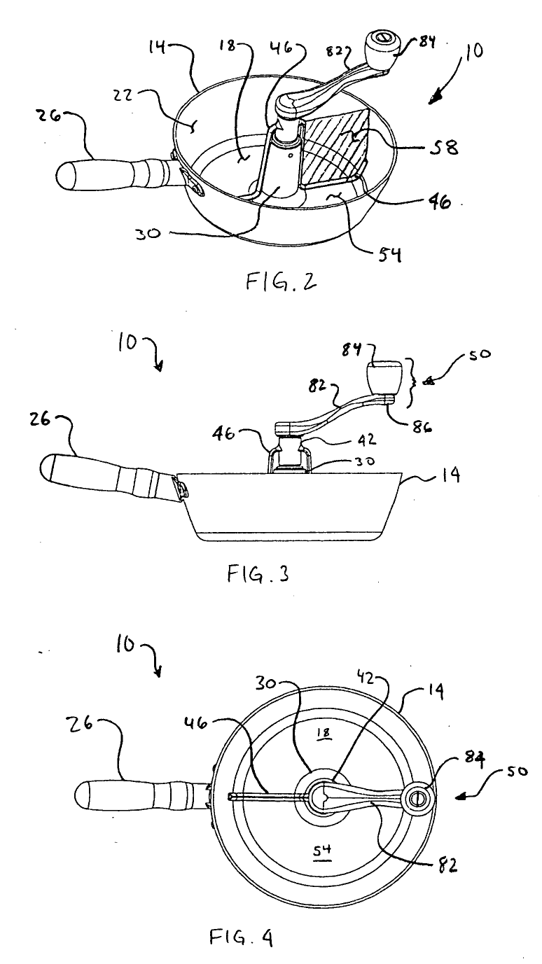

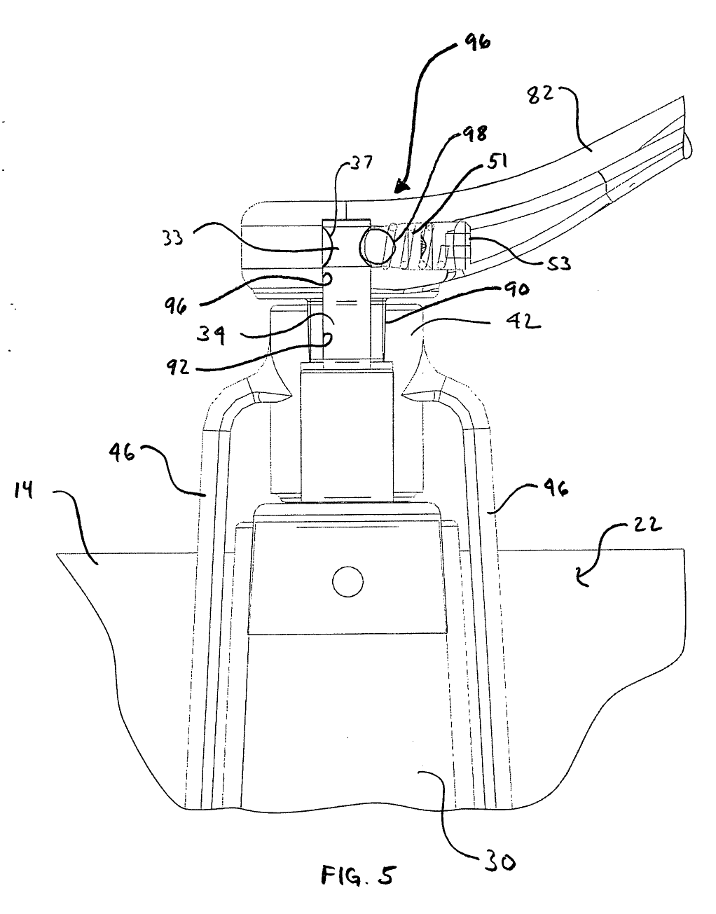

As illustrated in FIGS. 1-4, a cooking container with an agitation device, indicated generally at 10, is shown for simultaneously roasting and agitating. The cooking container 10 can be a roasting or frying pan 14. The pan 14 can have a bottom surface 18, a perimeter sidewall 22 and handle 26. A central pedestal 30 can be coupled to the approximate center of the bottom surface 18. An axle rod 34 can be coupled to the approximate center of the top surface 38 of the central pedestal. A collar 42 can be rotatably coupled to the axle rod above the central pedestal. One or more agitation utensils 46 can be coupled to the collar 42. A rotator, indicated generally at 50, can be removably coupled to the collar 42.

The pan 14 can be any common cooking container, such as a roasting or frying pan, that has a bottom surface 18 that can be placed upon a stove top or other suitable heat source. The pan 14 can also have a sidewall 22 extending upward from a periphery 20 of the bottom 18. The pan 14 can be constructed from common cooking materials, such as glass or metal, as is known in the art. It will be appreciated that the handle 26 is not a necessary element and the agitation device can work equally well in a pot without a handle.

The sidewall 22 can extend upward from the periphery of the bottom surface 18. The sidewall 22 can have a height sufficient for containing large bulk food ingredients such as nuts. The sidewall 22 can also be perpendicular or at an oblique angle with the bottom surface 18.

The central pedestal 30 can also extend upward from the bottom surface 18. The central pedestal 30 can be integrally formed with the pan 14, or can be formed separately and attached to the pan 14 in a substantially central location of the bottom surface 18. The central pedestal 30 can form an annular cooking surface 54 on the bottom surface 18 inside the pan 14. The central pedestal 30 can also form a toroidal cooking volume 58, or ring, between the central pedestal, the sidewall 22, and the annular cooking surface 54. A cross section of the toroidal cooking volume 58 is shown by cross hatching in FIG. 2.

The axle rod 34 can extend upward from the top surface 38 of the central pedestal 30. The axle rod 34 can be machined from the same stock part as the central pedestal, or can be a separate part attached to the central pedestal 30. The axle rod 34 can be configured to hold bearings, bushings, or other friction reducing guidance elements as known in the art to facilitate rotation of the collar placed on the axle rod.

The collar 42 can be configured to receive, or fit over, the axle rod 34 and turn thereon. The collar 42 can include bushings or bearings as known in the art to facilitate rotation of the collar on the axle rod 34. Alternatively, a collar or bearing can be mounted on the pedestal 30, and the rotator 50 can include a rod that is insertable into the collar 42 or bearing.

The agitation utensil(s) 46 can be configured to move through the toroidal cooking volume 58 above the annular cooking surface 54. The agitation utensil(s) 46 can have a flat triangular longitudinal cross-sectional shape, with a bottom surface facing the pan surface, and two upper inclined surfaces, or a leading surface and trailing surface, so that the agitation utensil 46 can be close to the bottom surface 18 at the ends and then angles up to an apex in the middle and then back down at an angle to meet the bottom surface 18 again. Thus, the leading and trailing surfaces can form oblique angles with respect to the pan surface. This shape allows for almonds or other nuts to pass over the top of the agitation utensil 46 so that the nuts can mix instead of simply being pushed around the pan 14 by the agitation utensil. The triangular shape can also provide a flat bottom that can prevent nuts from wedging underneath the agitation utensil. A round bar shape agitation utensil can allow nuts to wedge underneath the utensil and jam up the stirring mechanism.

The agitation utensil(s) 46 can be arcuate stirring rods that can include a downward section 62 that extends downward from the collar 42 along the body of the central pedestal 30 toward the bottom surface 18. A radial section 66 can be integrally formed with the downward section and can extend radially across the annular cooking surface 54. The radial section 66 can be positioned on or slightly above the annular cooking surface 54 and can be made out of various material such as metal or plastic or wood. An upward section 70 can be integrally formed with the radial section 66 and can extend upward from the radial section along at least a portion of the sidewall 22.

It will be appreciated that the agitation utensils 46 can be arcuate stirring rods as shown in the figures and described above or the agitation utensils can be other means for agitation such as straight stirring rods, whisks, spatulas, spoons, and grating. Other suitable means for agitation as known in the art can also be used.

It is a particular advantage of the present invention that the agitation utensils 46 can agitate the contents of the cooking volume of the pan 14 adjacent the bottom surface 18 of the pan. In this way the agitation utensils can agitate the contents of the cooking container nearest the heat source and reduce or prevent overheating and burning due to stagnation or unagitated contents near the heated bottom surface of the pan. Thus, the a cooking container of the present invention can be a roasting or frying pan for roasting and glazing almonds and other nuts, that has a stirring device that advantageously can agitate the contents of the pan without leaving an undisturbed, or stagnant location where the contents may burn.

It is another particular advantage of the present invention that the central pedestal 30 supports the agitation utensils from an approximate center of the bottom surface of the pan. Many types of cooking containers with agitation utensils require a lid to suspend or support the cooking utensils in the cooking volume of the pan. It will be appreciated that a lid or other supporting structure over the cooking volume can block the view of the contents of the pan making it easier to overheat and burn the contents. In contrast, the cooking container of the present invention supports the agitation device on a central pedestal that advantageously does not block the view of the contents of the cooking container. In this way the user of the pan can continually monitor and watch the contents to ensure adequate heating without burning the contents.

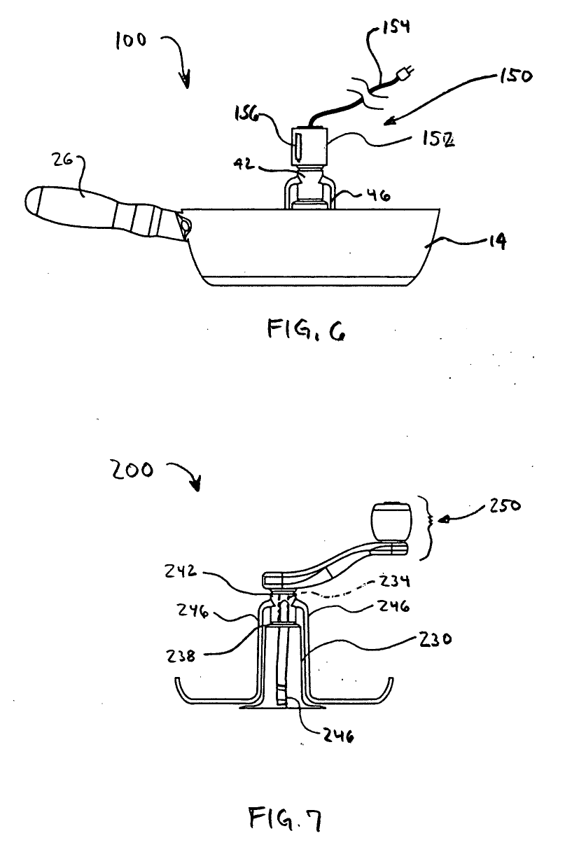

The rotator 50 can be removably coupled to the collar 42 and can rotate the collar. The rotator can be removably coupled to the collar above the pedestal 30. The rotator 50 can rotate the collar 42 while the bottom surface 18 of the cooking container 10 is disposed on a stove top cooking surface. In one aspect, the rotator 50 can include a handle 84 as shown in FIGS. 1-4. In another aspect, the rotator 50 can include an electric motor 152 as shown in FIG. 6. The rotator 50 is one example of means for turning the agitation utensils 46. Other suitable means for turning, as known in the art, can also be used.

In the case the rotator 50 includes a handle 84, as shown in FIGS. 1-4, the handle can be coupled to an arm 82 that can be operatively coupled to the collar and rotatable with the collar. The arm 82 can extend radially from the collar to a distal end 86 and the handle 84 can be coupled to the distal end 86. The arm 82 can also include a polygonally shaped protrusion 90 that can extend from a proximal end 88 of the arm 82. The polygonally shaped protrusion 90 can be sized and shaped to it within a corresponding polygonally shaped aperture 92 in the collar 42. In this way the polygonally shaped protrusion 90 can engage the polygonally shaped aperture 92 to rotate the collar 42 when the arm 82 is rotated. It will be appreciated that the protrusion 90 can be associated with the collar 42 and the aperture 92 can be associated with the arm 82 and still provide the engagement between the arm 82 and the collar 42 so as to rotate the collar.

It is a particular advantage of the present invention that the rotator 50 can be disposed above the central pedestal 30 thereby allowing the cooking container 10 to be placed on a flat stove top cooking surface. Many other cooking containers with attached agitation utensils have rotating mechanisms disposed below the cooking container. It will be appreciated having the rotator disposed below the cooking container prevents the cooking container from being used on a stove top cooking surface as is commonly used in domestic kitchens. Consequently, these types of cooking container not only have the rotator below the cooking container, but must also supply a heat source to heat the cooking container since the cooking container cannot be placed on a stove top. In contrast, the cooking container of the present invention advantageously has the rotator disposed above the central pedestal so that no structure interferes with the bottom surface of the cooking container which can be placed on a common domestic stove top, thereby eliminating the need for a separate heat source.

Referring to FIG. 5, the axle rod 34 can extend from the central pedestal 30 through the collar 42 and into an aperture 94 in the polygonally shaped protrusion 23 of the arm 25. The protrusion 23 can also include a detent, indicated generally at 96. For example, the detent 96 can be a ball bearing 98 biased to an engaged position by a spring 51 secured to the arm 82 by a set screw 53. The end 33 of the axle rod 34 that extends into the aperture 96 can be sized and shaped to receive the ball bearing 98. Specifically, the axle rod 34 can have an annular indentation or groove 37, while the rotator arm 82 can have a spring biased detent 51 or bearing that is received within the annular indentation. As the axel rod 34 is inserted into an opening in the rotator arm 82, the detent or bearing moves out of the opening and then snaps into annular indentation. Thus, the detent 96 can be engageable with the axle rod 34 to axially secure the arm 82 to the axle rod 34.

As illustrated in FIG. 6, a cooking container with an agitation device, indicated generally at 100, in accordance with another embodiment of the present invention is shown that can has a powered agitation device. The cooking container 100 can be similar in many respects to the cooking container 10 described above and shown in FIGS. 1-4. Additionally, the rotator 150 for rotating the agitation utensils 46 can be an electric motor 152. The electric motor 152 can include a power source such as a power cord 154 that can receive power from an electrical socket, or a battery 156. It will be appreciated that the motor 152 can also have a protrusion or aperture as described above and engage the mating protrusion or aperture in the collar 42 in order to rotate the collar.

As illustrated in FIG. 7, an agitation device, indicated generally at 200, in accordance with the present invention is shown that can be inserted into a conventional off the shelf cooking container (not shown), such as a frying or roasting pan, or pot. The agitation device 200 can be similar in many respects to the agitation device described above and shown in FIGS. 1-4. Additionally, the agitation device 200 can have a central pedestal 230 that can be placed on a bottom surface of a cooking container to form an annular cooking surface on the bottom surface and a toroidal cooking volume between the central pedestal 230 and a sidewall of the cooking container. An axle rod 234, shown in dashed lines in FIG. 7, can be coupled to a central location on a top surface 238 of the central pedestal. A collar 242 can be rotatably coupled to the axle rod above the central pedestal. At least one agitation utensil(s) 246 can be removably coupled to the collar. A rotator 250 can be removably coupled to the collar to rotate the collar thereby rotating the agitation utensils through the toroidal volume.

The at least one agitation utensil(s) 246 can move through the toroidal cooking volume above the annular cooking surface. The agitation utensils can be equally spaced apart about the central pedestal 230 and collar 242. The agitation utensils can contact the sidewall of the cooking container to center the central pedestal on the bottom surface of the cooking container and provide stability to the agitation device.

The central pedestal 230 can be weighted or have means for coupling to the bottom surface of the pan in order to help retain the central pedestal at the approximate center of the pan. For example, the central pedestal can include a magnet or electromagnet that can engage the bottom surface of the pan to hold the central pedestal in place while the agitation utensil is turned by the rotator.

The present invention can also provide for a method for agitating food in a cooking container including providing a cooking container having an agitation utensil rotatably coupled to a central pedestal. Food ingredients can be placed into the cooking container. The cooking container can be placed on a heat source. The agitation device can be rotated to agitate the food ingredients to prevent stagnation and burning while over the heat source. Foods that can utilize the invention include almonds and glaze, soup, etc.

The present invention can also provide for a method for cooking using a self-centering agitation device in a cooking container including providing a cooking container. A set of at least three agitation utensils that correspond in size to the cooking container can be selected. The set of at least one agitation utensils can be attached to a collar. The collar can be placed on an axle rod that is coupled to a central pedestal. The central pedestal can be placed into the cooking container where the agitation utensils can center the central pedestal within the cooking container. The cooking container can be placed on a heat source. Food ingredients can be placed into the container. The collar can be rotated thereby rotating the agitation utensils to agitate the food ingredients and prevent stagnation and burning.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed:

1. A cooking container with an agitation device, comprising:
a) a pan, including a bottom surface and a perimeter sidewall extending upward from the bottom surface;
b) a central pedestal, at a central location of the bottom surface and extending upward therefrom, forming a substantially annular cooking surface on the bottom surface and a subtantially toroidal cooking volume between the central pedestal and the sidewall;
c) an axle rod, coupled to a top of the central pedestal and extending above the central pedestal;
d) a collar, coupled to the axle rod above the central pedestal, and rotatable with respect to the pedestal;
e) at least one agitation utensil, coupled to the collar, configured to move through the toroidal cooking volume above the annular cooking surface as the collar rotates with respect to the pedestal;
f) an arm, operatively coupled to the collar, rotatable with the coller, and extending radially from the collar to a distal end; and
g) a handle, rotatably coupled to the distal end of the arm.

2. A container in accordance with claim 1, wherein the agitation utensil is an arcuate stirring rod.

3. A container in accordance with claim 1, wherein the agitation utensil extends downward from the collar, along the central pedestal, radially across the annular cooking surface, and upward along at least a portion of the sidewall.

4. A container in accordance with claim 1, wherein the agitation utensil has a longitudinal cross-section with a triangular shape.

5. A container in accordance with claim 1, wherein the arm further includes a polygonally shaped protrusion extending from a proximal end, sized and shaped to fit within a corresponding polygonally shaped aperture in the collar, and wherein the polygonally shaped protrusion is configured to engage the polygonally shaped aperture to rotate the collar when the arm is rotated.

6. A container in accordance with claim 4, wherein the axle rod extends from the pedestal through the collar and into the polygonally shaped protrusion of the arm and the protrusion further includes a detent engageable with the axle rod to axially secure the arm to the axle rod.

7. A container in accordance with claim 6, wherein the bearing detent further includes a ball bearing biased to an engaged position by a spring secured to the arm by a set screw, and an end of the axle rod is sized and shaped to the receive the ball bearing.

8. A container in accordance with claim 1, wherein the pan has a flat bottom configured to be disposed on a stove.

9. A cooking container with an agitation device, comprising:
a) a pan, including a bottom surface and a perimeter sidewall extending upward from the bottom surface;
b) a central pedestal, at a central location of the bottom surface and extending upward therefrom, forming a substantially annular cooking surface on the bottom surface and a subtantially toroidal cooking volume between the central pedestal and the sidewall;
c) an axle rod, coupled to a top of the central pedestal and extending above the central pedestal;
d) a collar, coupled to the axle rod above the central pedestal, and rotatable with respect to the pedestal;
e) at least one agitation utensil, coupled to the collar, configured to move through the toroidal cooking volume above the annular cooking surface as the collar rotates with respect to the pedestal;
f) an electric motor, removably coupled to the collar, and configured to rotate the collar; and
g) a power source, disposed on the motor.

10. A cooking container in accordance with claim 9, wherein the power source includes a battery.

11. A cooking container in accordance with claim 9, wherein the agitation utensil extends downward from the collar, along the central pedestal, radially across the annular cooking surface, and upward along at least a portion of the sidewall.

12. A cooking container with an agitation device, comprising:
a) a pan, including a bottom surface and a perimeter sidewall extending upward from the bottom surface;
b) a central pedestal, at a central location of the bottom surface and extending upward therefrom, forming a substantially annular cooking surface on the bottom surface and a subtantially toroidal cooking volume between the central pedestal and the sidewall;
c) an axle rod, coupled to a top of the central pedestal and extending above the central pedestal;
d) a collar, coupled to the axle rod above the central pedestal, and rotatable with respect to the pedestal;
e) at least one agitation utensil, coupled to the collar, configured to move through the toroidal cooking volume above the annular cooking surface as the collar rotates with respect to the pedestal, the agitation utensil extending downward from the collar, along the central pedestal, radially across the annular cooking surface, and upward along at least a portion of the sidewall; and
f) a rotator, removably coupled to the collar above the pedestal and configured to rotate the collar while the bottom surface of the cooking container is disposed on a stove top cooking surface.

13. A container in accordance with claim 12, wherein the rotator further includes:
a) an arm, operatively coupled to the collar at a distal end, rotatable with the coller, and extending radially from the collar to a distal end; and
b) a handle, rotatably coupled to the distal end of the arm.

14. A pan in accordance with claim 12, wherein the means for turning further comprises:
an electric motor, removably coupled to the collar, and configured to rotate the collar.

15. A pan in accordance with claim 12, the agitation utensils include stirring rods that extend downward from the collar, along the central pedestal, radially across the annular cooking surface, and upward along at least a portion of the perimeter sidewall.

16. A pan in accordance with claim 12, the agitation utensils are selected from a group consisting of:
a) arcuate stirring rods,
b) straight stirring rods,
c) whisks,
d) spatulas,
e) spoons, and
f) grating.

17. An agitation device for cooking containers, comprising:
a) a central pedestal, configured to be placed on a bottom surface of a cooking container to form an annular cooking surface on the bottom surface and a toroidal cooking area between the central pedestal and a perimeter sidewall of the cooking container;
b) an axle rod, coupled to a top of the central pedestal and extending above the central pedestal;
c) a collar, rotatably coupled to the axle rod above the central pedestal;
d) at least one agitation utensil, removably coupled to the collar, configured to move through the toroidal cooking area above the annular cooking surface, wherein the at leaste one agitation utensil contacts the sidewall of the cooking container to approximately center the central pedestal on the bottom surface of the cooking container; and
e) a rotator, removably coupled to the collar above the pedestal and configured to rotate the collar while the bottom of the cooking container is disposed on a stove top cooking surface.

18. An agitation device in accordance with claim 17, further comprising at least three agitation utensils equally spaced apart and configured to contact the sidewall of the cooking container to approximately center the central pedestal on the bottom surface of the cooking container.

19. A method for agitating food in a cooking container, comprising the steps of:
a) providing a cooking container having an agitation utensil rotatably coupled to a central pedestal at a central location of a bottom surface of the cooking container and extending upward therefrom, forming a substantially annular cooking surface on the bottom surface and a subtantially toroidal cooking volume between the central pedestal and a perimeter sidewall of the container;
b) placing food ingredients into the toroidal cooking volume of the cooking container;
c) placing the cooking container on a stove top; and
d) rotating the agitation device with a rotator to agitate the food ingredients to prevent stagnation and burning.

20. A method for cooking using a self centering agitation device in a cooking container, comprising the steps of:
a) providing a cooking container;
b) selecting a set of at least one agitation utensil that corresponds in size to the cooking container;
b) attaching at least one agitation utensils to a collar;
c) placing the collar on an axle rod coupled to a central pedestal;
d) placing the central pedestal so that the at least one utensils contact a perimeter sidewall of the cooking container to space the central pedestal equidistant from the perimeter sidewall at an approximate center of the cooking container;
e) placing a cooking container on a heat source;
f) placing food ingredients in the container; and
g) rotating the collar with a rotator to agitate the food ingredients with the at least one utensils to prevent stagnation and burning.
